(19) United States
(12) Patent Application Publication
(10) Pub. No.: US 2009/0295034 A1
(43) Pub. Date: Dec. 3, 2009

(54) METHOD OF MAKING ACTIVATED CARBON MONOLITH

(75) Inventors: XIAOQUN WU, WILMINGTON, DE (US); SHOWGUEI YEH, WILMINGTON, DE (US); CHARLES ZHOU, LAUREL, MD (US); HUIFANG CHEN, WILMINGTON, DE (US)

Correspondence Address: CM - TEC, INC., 1 INNOVATION WAY, SUITE 100, NEWARK, DE, 19711, US

(73) Assignee: CM-TEC, INC., Newark, DE (US)

(21) Appl. No.: 12/131,380

(22) Filed: Jun. 2, 2008

(51) Int. Cl. B28B 3/02

(52) U.S. Cl. 264/319

(57) ABSTRACT

A process for making activated carbon monolith using PTFE as binder is disclosed and described. The process includes carbon-PTFE paste preparation, shearing the paste in a calender with hot rollers, and forming carbon monoliths using compression shaping equipment.

The United States Government has rights in this invention pursuant to Contract No. DE-FG02-05ER84211 between the US Department of Energy and CM-Tec, Inc.

### FIELD OF THE INVENTION

The present invention relates generally to activated carbon preparation process, and more specifically to a process for the preparation of activated carbon monoliths for natural gas storage with large volumetric capacity.

### BACKGROUND OF THE INVENTION

Stored natural gas has been used for many commercial applications including natural gas transportation and natural gas driven vehicles. Compressed natural gas storage (CNG) and liquefied (or cryogenic) natural gas storage (LNG) are two prevailing storage methods. CNG unit works at very high pressure (2000-3000 psi) so that a multi-stage compressor system is necessary for container refill. Safety issue and costly refill system are its drawbacks. While LNG unit needs cryogenic conditions. Due to the vaporization of LNG unit under external heating condition, the stored natural gas can only last one week. Costly cryogenic refill system is a disadvantage as well.

Adsorbed natural gas storage (ANG) is a new method under development in the recent years. Owing to the use of adsorbent, primarily activated carbon, the ANG unit can store comparable natural gas in a portion of pressure that CNG unit uses. Cracknell et al. (1993) and Cook et al. (1999) investigated adsorbed storage of natural gas (methane) and indicated that adsorptive storage is a realistic alternative to compressed natural gas. However, the low bulk density of the carbons (and hence low volumetric capacity of the storage system) has been identified as a limiting factor in the development.

In recent years, Evans et al. (1999) and Lozano-Castelló et al. (2001) published the work of making activated carbons based on anthracite coal or petroleum coke, which were developed with micropore volumes up to 1.2 cm³/g. However, these materials have an inappropriate pore size distribution for the storage of methane. Carbons based on phenolic resins as the precursor have been developed as catalyst supports. Because the micropore size distribution in phenolic resin carbons slightly changes with the degree of activation, it is possible to develop carbons with large micropore volumes and also with a very narrow micropore size distribution. However, for the application of natural gas storage, it is relatively expensive to make activated carbon using such a process.

The generated activated carbon materials can be pressed into different shapes with packing bulk density of 0.36˜0.8 g/cm³ depending on precursors. Thus, the adsorbent-based storage system may have higher volume capacity.

Activated carbons are highly porous materials in which a suitable precursor has been mildly oxidized—activated—to reveal pores inherent in the precursor structure. The pores are formed by the slit-spacings between disordered graphene layers that make up the amorphous carbon. If there is a large fraction of micropores (defined as pores of diameter less than 20 Å-molecular methane's diameter is about 3.5 Å), then the combined effect of two closely spaced walls enhances the van der Waals forces on small molecules and so makes the adsorption of permanent gases possible. Methane is concentrated in these micropores at substantially lower pressures than in high-pressure cylinders. In larger mesopores and macropores, the methane molecules interact with only one wall, so the adsorption forces are much smaller and these pores have no effect on adsorption capacity.

In general, two types of activation methods are known. Physical activation uses CO₂ or steam at temperatures of 750° to 900° C. While chemical activation invokes more complex chemistry using alkali oxides, carbonates or zinc salts impregnated into the precursor and temperatures between 500° and 900° C. Chemically activated powdery carbon has shown relatively high weight capacity for natural gas storage system.

Lozano-Castelló et al. (2002) published their work on the shaped activated carbon for methane storage. In their work, several binders were used, such as humic acid-derived sodium salt (HAS) from Acros organics, polyvinyl alcohol (PVA), novolac phenolic resin (PR), waterlink suteliffe carbons (WSC), Teflon (TF), adhesive cellulose-based binder (ADH). And the percentage of binders used in shaped carbon varies in the range of 10-20wt %. The approaches they used to fabricate the shaped activated carbon materials involve heat molding at 135-200° C. and pyrolyzing at 750° C. Compared with the packed activated carbon powder, the density of the shaped activated carbon only increases slightly, but the methane storage decreases significantly.

Since there are voids between carbon particles, the powdery carbon generally displays low packing density and rarely achieves ideal volumetric capacity of natural gas storage, which, however, is an important factor for some applications, such as vehicle on-board ANG systems. It would be of value to provide a process to make powdery activated carbon into monolith shape with increased bulk density and enhanced ANG volumetric capacity. This may be achieved by using the method of the present invention.

### SUMMARY OF THE INVENTION

It is an object of the present invention to provide a process of preparing shaped activated carbon materials with the following merits:
a. Low binder usage,
b. simple operational procedures and no need of high temperatures for shaping,
c. high bulk density without loss of adsorption capacity.

This combination of features can result in shaped carbon materials with large volumetric methane storage capacity.

The foregoing and other objects, features, aspects and advantages of the present invention will become more apparent from the detailed description of the present invention below.

### DETAILED DESCRIPTION OF THE INVENTION

In the present invention, the shaped activated carbon material for ANG applications is made through two steps, powdery carbon preparation and carbon monolith formation. To demonstrate the present invention, the powdery activated carbon was prepared via chemical activation process; in which, anthracite coal was used as precursor and potassium hydroxide as activation agent. The process of chemically activating carbon sample from coals involves the following procedures:
i) grinding coal chunk to desired size,
ii) weighing KOH powder and mixing it together with coal powder,
iii) transferring coal/KOH mixture into a ceramic or stainless steel container, putting the sample container into a high-temperature furnace, and purging the furnace with nitrogen,
iv) pre-activation: heating up sample to 400° C. with ramp rate of 10° C./min, and dwelling sample at 400° C. for 1 hour,
v) activation: after pre-activation dwelling, heating up sample again to 800° C. with a rate of 10° C./min, and dwelling sample at 800° C. for 1 hour,
vi) post activation treatment: after cooling down to 300° C., introducing moisture into the furnace with the purging flow, taking out the sample container as the temperature is down to room temperature; using Dl water, diluted HCl solution, and deionized (Dl) water, to wash the sample to pH˜7.0, drying sample at 120° C. overnight.

Thus made powdery carbon is then fabricated into monolith shape by using the procedures given below:
i) PTFE solution preparation—in a container, polytetrafluoroethylene (PTFE) emulsion is prepared using Dl water to a dilute solution.
ii) Carbon-PTFE paste preparation—a weighed amount of powdery activated carbon is put in a container. Under stirring, the PTFE solution is added into the carbon container slowly and Dl water is then added until the carbon-PTFE mixture becomes a paste.
iii) Shearing treatment—the carbon-PTFE paste is treated using a calender with hot rollers. The paste is sheared repeatedly between hot rollers. While the paste is dried on hot rollers, it is gradually formed into tape shape, and then is dried in oven at the temperature of 105-150° C.
iv) Carbon monolith formation—under compression with a machine such as tablet press and compression molding, the carbon-PTFE tape is made into monoliths at ambient temperature.

In the above procedures, PTFE is used as a binder material. There are some merits of using PTFE as a binder. First, only a small proportion of PTFE is needed for carbon powder binding. Second, high temperature is not necessary for carbon monolith formation. However, good binding effect can only be obtained once the carbon-PTFE paste undergoes shearing treatment at certain temperatures, e.g., 70-150° C. Higher temperature up to 327° C. (PTFE melting point) is also effective, but not required. It is sufficient to shear carbon-PTFE paste at 80-100° C. for effective binding. Generally the operational temperature of a calender can be as high as 250° C. Therefore such a shearing treatment under the said temperatures (80-100° C.) can be easily performed on a calender.

The shearing treatment prior to the formation of carbon monolith under pressing is necessary to achieve high pressing density and consequently a significant improvement in volumetric natural gas storage capacity of carbon materials. In experiments, a trial was performed, in which a dried carbon-PTFE mixture (obtained from drying the said carbon-PTFE paste) was used for making carbon monoliths without undergoing shearing treatment. The formed monoliths were not firm enough and the density could not be increased as much as that obtained from a process with shearing treatment.

### EXAMPLE 1

### Preparation of Powdery Activated Carbon

300 g ground Pennsylvania anthracite with all particles passing through 140 mesh sieve was mixed with 600 g KOH powder uniformly, and then the mixed powder was transferred into a ceramic or stainless steel container. The sample container was put in a high-temperature furnace, and nitrogen purging flow was introduced on the top of the surface of coal/KOH powder layer. The nitrogen flow rate was set at 7 liter/min. The activation process involves two steps, i.e., pre-activation and activation. The pre-activation was first performed by heating up sample to 400° C. with ramp rate of 10° C./min, and dwelling sample at 400° C. for 1 hour. After pre-activation dwelling, the sample was heated up to 800° C. with a ramp rate of 10° C./min, and the sample dwells at 800° C. for 1 hour. After activation dwelling, the sample was cooled down to 300° C., moisture was introduced into the furnace using an air bubbler for 20 min.

The sample container was taken out from the furnace as the temperature was down to room temperature. The sample was washed using Dl water and filtered, and soaked in diluted HCl solution with pH˜5 for 1 hour and then filtered. The sample was washed using Dl water again until pH˜7.0, and then dried in oven at 120° C. overnight. The dried activated carbon sample was collected and stored in a bottle for further use.

### EXAMPLE 2

### Preparation of Carbon-PTFE Paste

100 g activated carbon powder was weighed and put in a 1000 ml glass beaker. A desired amount of PTFE emulsion, which has PTFE particle size around 5 micron and PTFE content of 35wt %, was weighed. The weighed PTFE emulsion was diluted using Dl water by 10-20 times. Under stirring, the diluted PTFE emulsion solution was added into the beaker containing carbon powder slowly and Dl water was then added until the carbon-PTFE mixture becomes a uniform paste.

### EXAMPLE 3

### Carbon-PTFE Paste Shearing

The prepared carbon-PTFE paste was sheared using a calender with hot rollers. The roller temperature was set at 100° C. The paste was sheared repeatedly between hot rollers. Meanwhile the water in the paste was driven out with heating by hot rollers. With the water being vaporized, the carbon-PTFE paste was gradually formed into tape shape. The formed carbon tape was then dried in oven at the temperature of 120° C. overnight.

### EXAMPLE 4

### Carbon Monolith Formation

Under compression with a machine such as tablet press and compression molding, the carbon-PTFE tape was made into monoliths at ambient temperature. Herein a tablet press with 1125 lbs press force was used, and the internal diameter of the punching hole on the die is 12 mm. The puncher moving distance was adjusted for making tablet monoliths in the thickness of 6 mm. Therefore the dimension of the monoliths is Diameter×Thickness: 12 mm×6 mm.

Two powdery activated carbon samples, that is, Carbon A and Carbon B, were used to make carbon monolith samples. Carbon A has a packing density of 0.45 g/ml and a volumetric methane storage capacity of 115 v/v (at 25° C. and standard pressure); while Carbon B has a packing density of 0.51 g/cm³ and a volumetric methane storage capacity of 121 v/v. In order to observe the effect of PTFE content on the density of the formed carbon monoliths, different PTFE weight percentages were used in experiments. The densities of the formed carbon monoliths were given in Table 1. In the experimental range, the density of carbon monoliths is not evidently affected by PTFE content. Through this shaping process, the powdery carbon with low packing density was made into carbon monoliths with relatively high density; in other words, the density increases by 65%.

### EXAMPLE 5

### Isotherm Analysis on Carbon Powder and Monolith Samples

Powdery carbon samples, Carbon A and Carbon B, and all formed carbon monoliths were analyzed for their methane storage capacities. The methane storage capacity of samples was measured by using isotherm adsorption method at room temperature. The storage capacity results are listed in Table 1. With the increase of PTFE content, the methane storage capacity of the carbon monoliths decreases, though the density of monoliths appears similar. Since PTFE is an inert binder, higher PTFE content may cause a reduction of carbon content in monolith hence a decrease of methane storage capacity. Through making carbon powder into monoliths, the methane storage capacity is improved by about 30%.

TABLE 1
Density and methane storage capacity of
carbon powder and monolith samples

| Powdery | Carbon Monolith | Density | Methane Storage |
|---|---|---|---|
| Carbon | PTFE content (wt %) | (g/cm³) | Capacity (v/v) |
| Carbon A | | 0.45 | 115 |
| | Monolith made from | | |
| | Carbon A | carbon monolith: | carbon monolith: |
| | 2 | 0.73 | 148 |
| | 3 | 0.76 | 150 |
| | 4 | 0.75 | 148 |
| | 5 | 0.73 | 147 |
| | 6 | 0.75 | 145 |
| Carbon B | | 0.51 | 121 |
| | Monolith made from | | |
| | Carbon B | carbon monolith: | carbon monolith: |
| | 3.5 | 0.84 | 158 |

Modifications and variations of the present invention will be obvious to those skilled in the art from the details of the foregoing description. Such modifications and variations are intended to be embraced by the appended claims.

1. A process for making activated carbon monolith comprising the steps of:
a. preparing activated carbon-PTFE paste using powdery activated carbon, diluted PTFE emulsion solution, and deionized water, under stirring.
b. shearing the carbon-PTFE paste using a calender with hot rollers. The paste is sheared repeatedly between hot rollers until the paste is dried and then a carbon-PTFE tape is formed into tape shape.
c. drying the carbon-PTFE tape in oven at elevated temperatures.
d. forming activated carbon monolith using tablet press or compression molding at ambient temperature.

2. The process of claim 1, wherein the carbon/PTFE weight ration of the said carbon-PTFE paste is between 98/2-90/10.

3. The process of claim 1, wherein the said shearing treatment is performed using a calender with hot rollers. The temperature of hot rollers is between 50-260° C. The shearing time is between 1-30 min.

4. The process of claim 1, wherein the activated carbon monolith is made using compression shaping equipment, typically, tablet press and compression molding unit.

5. The process of claim 1, wherein the made carbon monoliths have the density 1.5-1.8 times as high as that of the original powdery carbon.

6. The process of claim 1, wherein the made carbon monoliths possess the volumetric natural gas storage capacity 1.2-1.4 times as high as that of the original powdery carbon.
